(19) United States
(12) Patent Application Publication
(10) Pub. No.: US 2025/0038561 A1
(43) Pub. Date: Jan. 30, 2025

(54) Advanced AI- Controlled Dual-Battery Charging System for Extended Range in Electric Vehicles.

(71) Applicant: Robert Lopez, New York, NY (US)

(72) Inventor: Robert Lopez, New York, NY (US)

(21) Appl. No.: 18/900,889

(22) Filed: Sep. 30, 2024

Related U.S. Application Data
(60) Provisional application No. 63/682,355, filed on Aug. 13, 2024.

(51) Int. Cl. H02J 7/14; B60L 50/60

(52) U.S. Cl. CPC H02J 7/1492; B60L 50/66; H02J 7/1423; H02J 7/1446

(57) ABSTRACT

The invention relates to an AI-controlled dual-battery charging system designed to optimize battery performance and extend the operational range of electric vehicles. The system incorporates a gyro wheel, an electronically controlled continuously variable transmission (ECVT), and an alternator or generator, all managed by an AI-driven Battery Management System (BMS) and Vehicle Control Unit (VCU). The AI dynamically regulates energy recovery and battery switching to ensure efficient power management. The system is adaptable for various battery-powered platforms, including electric bikes, scooters, drones, and exercise equipment, providing efficient energy recovery through momentum and real-time optimization.

### CROSS-REFERENCE TO RELATED APPLICATION

This application claims the benefit of U.S. Provisional Application No. 63/682,355, filed on Aug. 13, 2024, the contents of which are incorporated herein by reference in their entirety.

### FIELD OF THE INVENTION

The present invention pertains to the field of Battery Management Systems (BMS), specifically focusing on AI-controlled dual-battery charging systems. These systems leverage advanced AI algorithms to optimize energy recovery and extend the range of electric vehicles through precise management of alternator field voltage, vehicle momentum, and battery health.

This invention further integrates a gyro-wheel-assisted dual-battery charging system, which harnesses the momentum of the vehicle to drive a gyro wheel connected to a planetary or Electronically Controlled Continuously Variable Transmission (ECVT) gear system. The gyro wheel generates torque to power an alternator or generator, recharging the secondary battery while minimizing inertia drag and maximizing energy efficiency.

The system is particularly suited for electric-powered commercial vehicles, such as trucks and buses, where efficient energy management and extended range are crucial for both urban and long-haul transport. The AI-driven Battery Management System (BMS) continuously optimizes the charging cycles of the battery packs, ensuring ongoing energy recovery, reducing vehicle downtime, and improving overall operational efficiency.

Moreover, the principles of this dual-battery and gyro-wheel system can be adapted for use in other electric-powered vehicles and devices. The benefits of this system are universally applicable across various modes of transportation and energy recovery platforms.

The system is designed to enhance performance and extend the operational range of a wide range of battery-powered vehicles and devices, including, but not limited to, electric trucks, buses, delivery vehicles, bikes, scooters, drones, and exercise equipment.

This application presents a single, unified invention that operates across various platforms, including electric-powered vehicles such as trucks, buses, scooters, electric bikes, drones, and battery-operated exercise equipment. **To prevent any potential restriction requirement**, we respectfully submit that the subject matter is directed toward one inventive concept, and thus, all claims are properly unified under a single system.

### DESCRIPTION OF RELATED ART

The increasing demand for electric vehicles (EVs) is driven by the need to reduce carbon emissions and mitigate environmental impact. Despite advancements, EV technology still faces significant challenges, particularly related to limited driving range.

Most current EVs rely on a single main battery pack and regenerative braking systems for energy recovery, which are insufficient to provide continuous in-motion charging and limit the operational range. The driving range of electric vehicles (EVs) is a significant barrier to widespread adoption.

Existing dual-battery systems and regenerative braking techniques provide some improvements but often fail to efficiently maximize energy recovery and battery longevity and they are often insufficient to fully recharge the battery during normal vehicle operation, necessitating frequent stops at charging stations.

Various attempts have been made to enhance the efficiency and mileage of electric vehicles (EVs), including integrating secondary battery packs, improving energy management systems, and developing more efficient charging methods.

For instance, U.S. Patent. No. 20230216326 see cited Page 34 ref-17, Hogan which has similarities to this present embodiment describes a dual battery system aimed at energy recovery that depicts its embodiments use of “auxiliary battery as a lithium-ion battery, and the primary battery can be of any type” and that effects its energy management and they are not two identical battery packs that are installed as one battery is of a lead acid type thus failing to optimize and balance the system.

This embodiment only references (ICE) internal combustion engine vehicles only and stated “provides the need for cranking power to start the vehicles gas engine” and thereby lacking components such as advance AI algorithm, gyro wheel or ECVT gear mechanisms thereby not useful or qualifies for improving an EV's range.

Similarly, U.S. Patent No. 20240253522 see cited Page 35 refer-20, Bishai. Also with some similarities to present embodiment outlines some improvements in energy management for extended range using the EV's existing regenerative system in the form of friction method for energy production, while innovative in its own right.

The embodiment describes a dual-battery charging system with similar components to this present embodiment but the level of intelligent control is not present in the prior-arts embodiment's dual battery system.

An explanation for this, it's that the prior arts system relies on a more traditional battery management charging methods such as the regenerative braking system and lacking key innovations to harness the vehicle's momentum for continuous battery charging.

This limitation necessitates frequent stops at charging stations, making long-distance travel still challenging with this older technology.

The prior art U.S. Patent No. 20120041627 see cited Page 34 refer-10, Tesla Motors, also very similar to present embodiment utilizing dual battery packs as well but the system manages two different types of battery packs.

The EV's charging system uses the same principle of charging methods of harnessing energy production through the use of wheel hub friction generators to charge its battery packs and again the technology is insufficient to fully recharge the battery packs during normal driving conditions, necessitating again for frequent stops at charging station stalls.

However, this existing embodiment, described also offers dual battery packs but it's based on one large main non-metal air battery pack and one small size metal-air battery pack that do not match in capacity or energy storage, resulting in disparate ampere-hour (Ah) ratings or watt-hour (Wh) capacities, but the packs are configured to operate at the same nominal voltage while differing in current handling and total energy storage capability.

The embodiment does not mention a main alternator or generator, it mentions for the purpose of extending a limited range of extra miles utilizing its wheel hub generators or dynamo electric braking technologies as also used in the other cited embodiments charging systems to produce its only electric energy back into the smaller battery pack that sends it to the larger main pack that eventually fails to keep the main battery pack at a positive 100 percent (SOC).

The current problems with the cited embodiments charging methods are that the use of friction brake hub generators that send electric energy back to a small backup battery pack only happens when the brake pedal is applied and also serves as a braking system as well to reduce vehicle speed afterwards it forwards this energy from the smaller battery to the main battery pack and no longer provides a charge to the backup battery when the vehicles brake pedal is again released.

These hub generators offer charging functions but they succumb to the negative side effects of massive inertia resistance because it drastically slows the vehicle down and no longer provides a charge to the backup battery when the vehicles has come to a stop.

Despite these advancements, these approaches often fall short of delivering significant improvements in real-world range due to limitations in their overall system design.

While regenerative braking systems help to some extent, they are insufficient alone to fully recharge the battery during normal driving conditions.

Specifically, the patents cited all lack advanced artificial intelligence (AI) algorithms, a gyro wheel mechanism, planetary or ECVT gear system leading to inefficiencies in real-world applications, such as inadequate algorithms for energy management or inefficiencies in the energy recovery mechanism, which result in suboptimal performance under practical conditions. These limitations contribute to the continued challenge of achieving substantial range improvements for EVs.

I will provide details how my invention addresses them in the subsequent sections of this application, particularly in the “Detailed Description of the Invention” section and ensure clarity in presenting how the present embodiment overcomes the shortcomings of the past existing embodiments charging methods.

### BACKGROUND OF THE INVENTION

Electric Vehicles (EVs) have become increasingly popular due to their environmental benefits and the push to reduce carbon emissions.

The Internal combustion engines (ICEs) used in conventional vehicles are significant contributors to atmospheric carbon dioxide emissions see cited references, which also contribute to global warming. Recent advancements in electric vehicles (EVs), which do not rely on ICEs, aim to mitigate this environmental impact.

As the demand for EVs with extended range increases, addressing these challenges becomes critical. Despite some advancements, EV technology still faces significant challenges, particularly related to limited driving range. Electric vehicles (EVs) have gained significant traction as an eco-friendly alternative to traditional gasoline-powered cars.

However, one of the major challenges facing the adoption of EVs is the limited driving range provided by current battery technologies. Lithium-ion batteries, commonly used in EVs, offer improvements in energy density but still fall short in terms of driving range and charging efficiency. For instance, a typical lithium-ion battery provides a driving range of approximately 200 miles on a full charge, and charging times can exceed 30 minutes even with fast-charging infrastructure.

Existing solutions, such as supercharging stations, have addressed some of the charging time issues but can accelerate battery wear and reduce overall battery life. Additionally, the energy density of current batteries remains constrained, limiting the driving range and practicality of EVs for long-distance travel.

Therefore, there is a pressing need for a new technology that not only extends the driving range of EVs but also supports ultra-fast charging while maintaining or even enhancing battery longevity.

The present invention addresses these needs by introducing an Advanced AI-Controlled Dual-Battery Charging System for Extended Range in Electric Vehicles (EVs), Scooters, Bikes, Drones, and exercise equipment as well as trucks and buses, including commercial delivery trucks. These vehicles have gained popularity due to their environmental benefits and the growing need to reduce carbon emissions.

Despite advancements in EV technology, a significant limitation remains the driving range, which is largely due to the reliance on a single main battery pack. With the growing use of battery-operated vehicles and other electrical equipment, there is a need for a system that can efficiently manage battery usage across various platforms.

The present embodiment provides instructions and solutions to address these issues, which will be explained in the subsequent sections of this application, particularly in the “Detailed Description of the Invention.” This section will clarify how the present embodiment overcomes the shortcomings of existing technology.

Additionally, there is an increasing demand for more efficient energy management in electric-powered commercial vehicles, such as electric trucks and buses, where extended range and reduced charging times are critical for both urban and long-distance operations.

The current invention addresses this by incorporating AI and a gyro-wheel assisted dual-battery charging system, which utilizes the vehicle's momentum to power a gyro wheel connected to a planetary or ECVT gear system that drives an alternator or generator, charging a secondary battery while the vehicle is in motion. By optimizing energy recovery during travel, this system reduces the reliance on external charging stations, particularly for electric trucks and buses, enhancing both the operational efficiency and driving range.

Most current EVs rely on a single main battery pack and regenerative braking systems for energy recovery, which are insufficient to provide continuous in-motion charging, thus limiting the operational range.

Existing dual-battery systems, such as those described in U.S. Patent No. 20230216326 (Hogan) and U.S. Patent No. 20240253522 (Bishai), offer some improvements by incorporating secondary battery packs and regenerative energy recovery mechanisms but continue to rely on older, less efficient friction charging methods, which are due for an upgrade.

However, these systems often lack efficient energy management, failing to optimize battery usage during vehicle operation.

Furthermore, these approaches do not integrate advanced artificial intelligence (Al) or momentum recovery mechanisms, such as a gyro wheel. Instead, they utilize friction-based hub generators commonly found in most EVs' energy management systems.

Traditionally, mechanical systems using stepped gears, such as planetary gear systems, are widely used in applications requiring controlled gear ratios. However, these systems may introduce inefficiencies in certain applications, particularly those requiring continuous adjustment of gear ratios for optimal performance.

One alternative technology that addresses this limitation is the Electronic Continuously Variable Transmission (ECVT), which allows for continuous gear ratio variation under variable loads without the need for stepped gears, as described in U.S. Pat. No. 4,589,303 see cited Page 36 refer-31. While ECVT systems improve power efficiency in some applications, they have not been effectively integrated with advanced energy management systems to optimize battery performance in electric vehicles.

Alternatively, an ECVT may be employed in place of the planetary gear system in the present embodiment allowing for the advantage of smooth transitions between gear ratios, potentially improving efficiency in energy recovery and power transmission applications.

Accordingly, there remains a need for modular solutions that provide users with flexibility based on specific operational requirements, particularly in systems designed for an advanced dual-battery charging system that dynamically manages energy usage and recovery in real-time. Such a system would optimize the driving range of electric vehicles without requiring frequent stops at charging stations.

Various attempts have been made to enhance the efficiency and mileage of EVs, including the integration of secondary battery packs, improved energy management systems, and more efficient charging methods.

However, these solutions often fall short of providing a significant improvement in range, as seen in the previously mentioned related arts and (cited in the references section).

Accordingly, there is a need for a dual-battery system that can efficiently manage energy usage and charging to extend the range of EVs while maintaining affordability and simplicity.

Currently, no other internal charging mechanism exists for EVs beyond friction generators and external charging stations, which are the two main classes of energy recovery methods.

Typically the EV user must basically drive to a set location to plug into a charging station to recharge depleted batteries.

One such method involves using an EV charging station that provides thermal conditioning as well before charging the lithium-ion battery pack see cited Page 34 ref-12 Patent No. 20150306974.

Existing lithium ion battery technologies, such as those disclosed in Patent No. 20130181511 see cited Page 34 refer-11, Tesla Motors, exhibit significant drawbacks in managing thermal performance due to the gel and liquid electrolyte materials used in their construction.

These batteries often suffer from extreme cold weather or inadequate heat dissipation in very hot weather, leading to overheating, decreased efficiency, and reduced drivability and range.

To mitigate these issues, an alternative type of battery pack, which will be detailed in the following sections, can solve these problems. Such an alternative would optimize the driving range of electric vehicles without requiring frequent stops at charging stations. Existing systems have not achieved this efficiently due to issues such as energy losses, increased mechanical resistance, and inadequate energy conversion methods.

The solution to the current problem is to implement a system that can harness the vehicle's momentum and convert it into usable electrical energy while the vehicle is in motion.

Therefore, there is a need for a novel system that can effectively extend the driving range of electric vehicles by optimizing energy recovery and battery management.

Existing prior art or patents cited in present embodiment, often provide dual battery packs tailored to specific vehicles or equipment. However, they lack an efficient mechanism to recharge batteries while the vehicle is in forward motion and are not easily adaptable across different battery-operated systems, such as electric bikes, scooters, drones, exercise equipment, trucks, buses, or commercial delivery trucks. These limitations highlight the need for a versatile solution that can extend battery life, improve range, and reduce the frequency of recharging stops.

### SUMMARY OF THE INVENTION

The present invention introduces an advanced AI-controlled dual-battery charging system designed to optimize battery performance and extend the operational range of electric vehicles (EVs), bikes, scooters, exercise equipment, drones, trucks, and buses.

The system leverages AI algorithms to manage the charging cycles and energy recovery processes in real-time, ensuring maximum efficiency and improved performance across a wide range of platforms.

The system integrates two independent battery packs, a gyro wheel mechanism, a planetary or Electronically Controlled Continuously Variable Transmission (ECVT) gear system, and an alternator or generator. This configuration allows one battery pack to power the vehicle or device while the other is being charged. The AI control system monitors critical factors such as vehicle speed, battery state of charge (SOC), and depth of discharge (DOD), adjusting the system to optimize efficiency and extend the range of the device or vehicle.

Key applications of this system include:
A. Electric Vehicles, Trucks, and Buses: The system improves range and reduces the need for frequent charging stops by efficiently managing energy recovery during vehicle operation. The integration of a gyro wheel mechanism and ECVT gear system ensures smooth transitions between power generation and usage, optimizing energy output.
B. Bikes and Scooters: In smaller vehicles, the system maximizes energy recovery during stop-and-go scenarios, making them more efficient and extending their range, particularly in urban environments.
C. Exercise Equipment: In devices such as stationary bikes, the system captures energy generated by the user and redirects it into the batteries, eliminating the need for external charging and or replacing dead batteries and increasing operational life.
D. Drones: The system introduces a unique enhancement for drones by integrating AI-controlled wing structures with servo motors. These wings adjust based on wind conditions, allowing the drone to harness wind energy to stay aloft while reducing motor power usage. Adjusts rotor blade pitch and capturing airflow to recharge batteries in flight. This significantly extends flight time and improves energy efficiency, making it ideal for long-range and high-endurance tasks such as surveillance or deliveries.

This embodiment provides a flexible and scalable solution that can be adapted to various vehicle types, with the AI-driven system optimizing energy management in real-time based on the specific requirements of each platform. The modular design ensures easy integration into existing vehicles and devices, making the system suitable for a wide range of applications from small electric scooters to larger commercial trucks.

### BRIEF DESCRIPTION OF THE DRAWINGS

It should be understood that the drawings, block diagrams, detailed descriptions, and figures provided are intended to further clarify the principles of the present embodiment.

These elements are included for illustrative purposes and may be modified by those skilled in the relevant arts. It is intended that the claims herein encompass all such modifications that fall within the scope of the invention.

Step-by-step instructions are used alongside figure references (denoted by letter and number) to explain the system's operation and the components involved, enhancing understanding, and certain aspects of this embodiment may appear intricate to individuals not skilled in the relevant areas, so extended explanations are provided to ensure comprehension of the full operational process. The accompanying figures, which are incorporated herein, form an integral part of the specification and illustrate the present embodiment.

FIG. 1 Version 1 (Diag-1 and Diag-2). Page 1 of 5

FIG. I: Depicts the assembly of the shell housing the gyro wheel and gear mechanism, showing the protective casing and internal components, including the gyro wheel, planetary ECVT gear system, and alternator or generator.

FIG. G1: Shows the overrunning clutch and gear assembly outside the unit, highlighting its role in allowing the gyro wheel to free-spin under certain conditions, thereby enhancing energy recovery efficiency.

FIG. T: Illustrates the location of the locking pin used to secure the gyro wheel on the shaft, ensuring stability and safety during high-speed operation.

FIG. O: Depicts the 85-pound gyro wheel held by a 30 mm shaft, which is critical in generating mechanical torque for the alternator or generator during vehicle motion.

FIG. P: Shows the side view of Diag-2, indicating bolt locations securing system components and ensuring structural integrity.

FIG. N: Depicts the cylindrical roller bearings that support the rotation of the gyro wheel and spur gear train, designed for high-speed operation and friction reduction.

FIG. K: Illustrates the gear train component attached to the output shaft of the ECVT gear box and then to the 30 mm gyro wheel shaft.

FIG. B: Represents the alternator or generator attached to the gyro wheel, responsible for converting mechanical energy into electrical energy to charge the battery packs.

FIG. W: Illustrates a 30 mm steel shaft that supports three bearings and two spur gears.

FIG. L: Shows the spur gear component attached to the 30 mm steel shaft, supporting three bearings and one additional spur gear, which meshes with the alternator or generator.

FIG. A: Similar to FIG. L, this figure shows the spur gear component attached to the 30 mm steel shaft, supporting three bearings and meshing with the alternator or generator.

FIG. S: Depicts the gear train component connected to the alternator or generator's output shaft, transferring generated electrical energy to the battery packs.

FIG. X: Depicts the planetary or ECVT gear box assembly.

FIG. R: Shows the output drive shaft from the hub spline connection to the ECVT's gear box input shaft assembly.

FIG. D: Depicts five steel dowels placed around the shell's perimeter for alignment, ensuring proper assembly of the shell.

FIG. C: Depicts five steel bolts securing the two halves of the shell, maintaining the structural integrity of the unit.

FIG. E: Depicts the height of the gyro wheel's steel shell, measuring 20 inches. FIG. F: Depicts the width of the gyro wheel's steel shell, measuring 13 inches.

FIG. G: Shows the overrunning clutch with a spur gear component attached to a 30 mm steel shaft, supporting three cylindrical roller bearings and meshing with the alternator or generator.

FIG. H: Represents the side view of the axle shaft connected to the ECVT gear box input shaft for drive power, which connects to the wheel's rim ring gear in Version 2 or the hub spline power drive in Version 1.

FIG. V: Shows the spur gear train component within the ECVT gear box.

FIG. Y: Represents a spur gear attached to the output shaft of the ECVT gear box.

FIG. M: Shows a spur gear attached to a shaft within the ECVT gear box.

FIG. 2: Diag-3. Version 2. Page 2 of 5

FIG. A: Depicts a gyro wheel with an integrated planetary or ECVT gear system housed within a steel casing, providing an overview of both gyro wheel assist units within the vehicle's powertrain.

FIG. B: Illustrates the alternator or generator driven by the gyro wheel through the planetary or ECVT gear system, responsible for converting mechanical energy into electrical energy for battery charging.

FIG. C: Shows the connection between the motor or alternator/generator output shafts and the gyro wheel's input shaft, crucial for transferring mechanical energy.

FIG. E: Depicts a spur gear train component attached to the end of the axle power shaft, meshing with other spur gear train components at the planetary or ECVT gear system.

FIG. N: Shows various cylindrical roller bearings supporting the shafts and rotation of the gyro wheel and spur gear train components, ensuring smooth operation and reducing friction.

FIG. R: Represents the axle shaft assembly connection between the wheel rim ring gear and planetary or ECVT gears.

FIGS. F, G, H: Illustrate planetary or ECVT gear train components and the overrunning clutch gear attached to the gyro wheel and connected to the alternator or generator.

FIG. O: Depicts the 60-pound gyro wheel, crucial for capturing and storing kinetic energy from the vehicle's momentum.

FIG. P: Shows the pivot points for the arm shaft for the second gyro wheel power drive version.

FIG. K: Illustrates the attached cooling fans for the motor, alternator, or generator, which manage the system's temperature during high-speed operation.

FIG. Z: Shows an alternative configuration (Version 2) featuring a vehicle wheel with an external ring gear welded to the inner side of the wheel's rim barrel for meshing with a beveled gear. This setup demonstrates a different integration method for the gyro wheel within the vehicle's drivetrain.

FIG. 3: Diag-4. Page 3 of 5

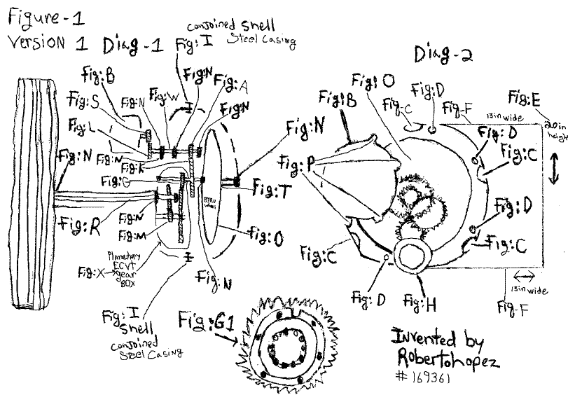

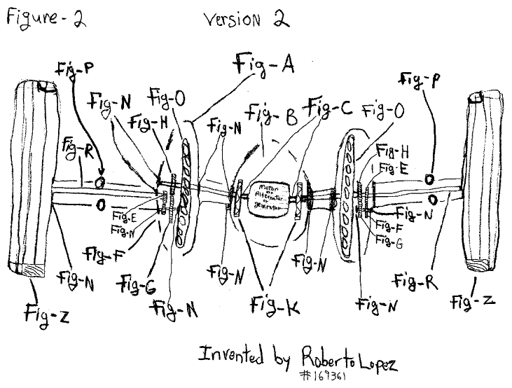

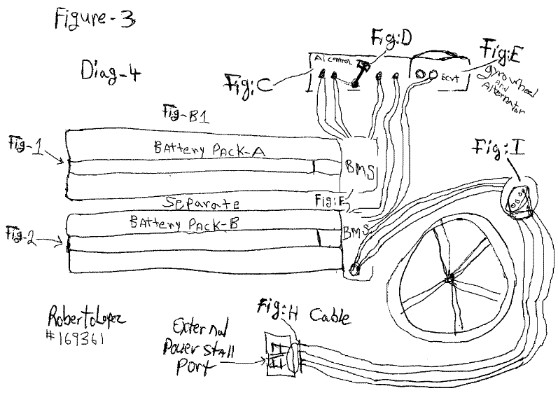

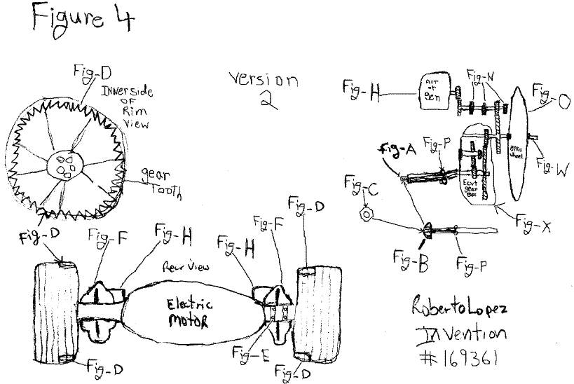

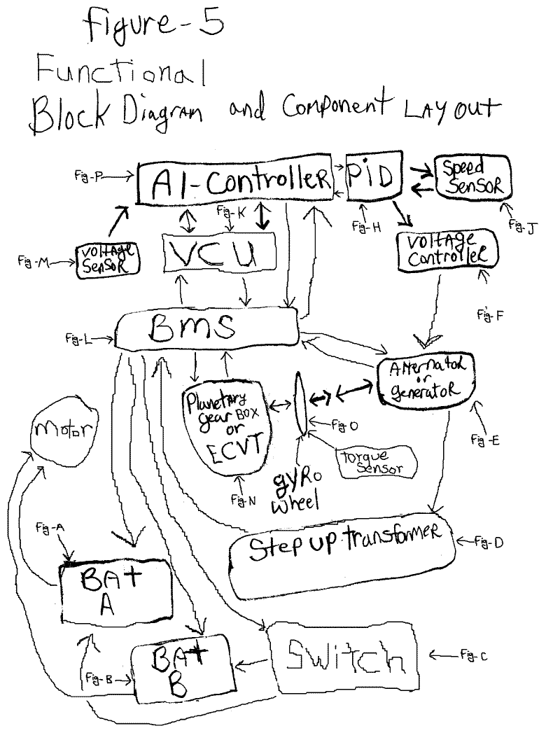

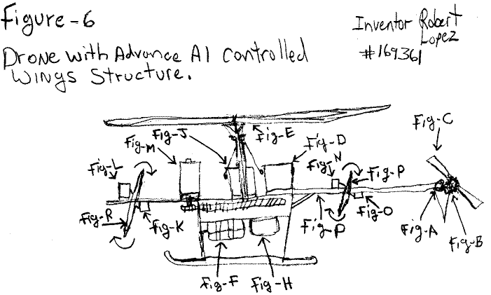

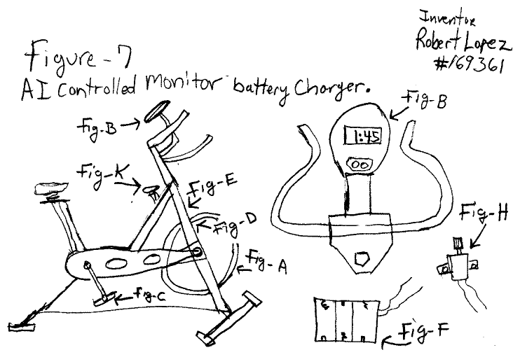

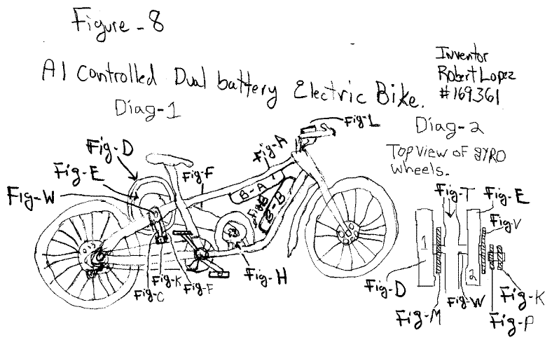

FIG. 1: Represents Battery Pack A with an included Battery Management System (BMS).

FIG. 2: Represents Battery Pack B with an included BMS.

FIG. B1: Shows the layout of the battery packs, ensuring independent management by the BMS for optimal performance.

FIG. C: Illustrates the unit where the mechanical switches and AI control interface with the BMS to manage the battery packs and their connection to the vehicle's powertrain.

FIG. D: Depicts the electrical or mechanical switch connections to the gyro wheel and alternator or generator system, showing the transition between charging the two battery packs.

FIG. E: Illustrates the gyro wheel, ECVT gear box, and alternator or generator setup, showing their interaction with the AI controller to generate electrical energy.

FIG. F: Shows the BMS units connected to each battery pack, responsible for monitoring SOC, DOD, and overall battery health.

FIG. I: Illustrates the connection of the EV's input port via a cable system to the external charging stall port, showing how the vehicle is charged externally.

FIG. H: Illustrates the external power stall port via a charging cable, showing how the vehicle is charged externally.

FIG. 4: Diag-5. Page 4 of 5

FIG. D: Depicts the inner side view of the wheel rim's ring gear, with visible gear teeth, representing the interface for the ECVT's input axle shaft with the beveled gear mesh connection.

FIG. O: Depicts the complete gyro wheel unit with the ECVT gear box assembly, showing how it attaches to the drive train axle in Version 2 with the pivoting axle and beveled gear.

FIG. B: Illustrates a bevel ball-type pinion gear attached to the axle, which is crucial for the interaction between the wheel's inner rim ring gear and the ECVT gear system in Version 2.

FIG. E: Shows the rear view of the axle, highlighting the square or round steel threaded U-bolts used to secure the gyro wheel unit.

FIG. A: Depicts the end tip of an axle that is threaded, designed to hold a splined beveled gear with a locking nut that interacts with the drive gear.

FIG. P: Shows a shaft pivoting point located near the wheel rim ring gear, providing meshing support to the rim ring gear.

FIG. C: Represents a locking nut located at the end of the threaded output shaft to secure the beveled gear onto the axle.

FIG. F: Illustrates potential locations for installing the Gyro Wheel Assist Units on the drive axle, either on the left or right side.

FIG. H: Depicts the alternator or generator attached to the Gyro Wheel Unit's housing.

FIG. W: Illustrates a 30 mm steel shaft that supported by three bearings and two spur gears.

FIG. 5: Functional Block Diagram and Component Layout. Page 5 of 5

This diagram illustrates the functional interconnection of the components in the AI-controlled dual-battery charging system. The system is orchestrated by the AI Controller and PID controller, which work together with several critical components to manage energy flow and optimize performance.

FIG. A: Represents Battery A, a primary energy storage unit.

FIG. B: Represents Battery B, a primary energy storage unit.

FIG. C: Depicts the switch that regulates battery utilization, determining which battery is active at any given time.

FIG. D: Shows energy directed through a step-up transformer for efficient voltage adjustment before being fed into the system.

FIG. O: Illustrates the gyro wheel, which provides energy recovery through mechanical means.

FIG. X: Depicts the planetary gearbox or ECVT, which provides energy recovery through mechanical means and is linked to the gyro wheel.

FIG. E: Represents the alternator or generator, which converts kinetic energy back into electrical energy.

FIG. F: Depicts the voltage controller, which the AI adjusts based on real-time data.

FIG. J: Shows the speed sensor that provides real-time data to the AI Controller, enabling the AI to adjust system parameters accordingly.

FIG. K: Represents the Vehicle Control Unit (VCU), which manages vehicle control.

FIG. L: Depicts the Battery Management System (BMS), which manages battery performance.

FIG. M: Represents a voltage sensor that provides critical feedback to the VCU, further refining energy management to ensure system stability and efficiency.

FIG. H: Depicts the PID Controller, which receives real-time data from the voltage and speed sensors to ensure stability and precision in system operations.

FIG. P: Illustrates the AI Controller, integrated with the VCU and BMS, which manages overall system control and adapts to changing conditions to ensure optimal energy distribution.

FIG. 6: Drone with Advanced AI-Controlled Wing Structure. Page 6 of 6

FIG. A: Represents the rear tail motor, which provides a counteracting force to the main rotor blade for stability during flight.

FIG. B: Depicts the rear tail gear connected to the rear tail rotor, facilitating the transfer of mechanical energy from the motor to the rotor blade.

FIG. C: Shows the rear tail rotor blade, responsible for stabilizing the drone during flight by countering the torque generated by the main rotor.

FIG. O: Illustrates the servo motor with 180-degree rotation capability, designed to adjust the wing's position to harness wind resistance, aiding in the drone's ability to hover and glide with reduced motor power.

FIG. N: Represents another servo motor with 180-degree rotation, similarly designed to adjust wing flaps for optimizing flight based on wind resistance and direction.

FIG. P: Shows the hollow body structure that houses the internal wiring running from the rear tail rotor motor to the AI controller, ensuring seamless communication between components.

FIG. H: Depicts the controller with an embedded advanced AI chip. The AI adjusts the wing flaps in real-time based on wind conditions, optimizing the drone's flight efficiency and extending battery life.

FIG. F: Represents the rechargeable battery pack that powers the drone's motors and servos, providing electrical energy for sustained operation.

FIG. D: Shows a servo motor with 180-degree rotation that pivots the main rotor bade for adjusting lift and flight stability.

FIG. J: Represents another servo motor with 180-degree rotation to pivot the main rotor blade, allowing for precise control over the drone's lift and maneuverability.

FIG. E: Depicts the main rotor blade, which is responsible for generating lift and keeping the drone in flight. Also for capturing airflow and recharging in flight.

FIG. M: Illustrates the main motor, which powers the rotor blade to provide the necessary lift for vertical flight.

FIG. L: Represents a servo motor with 180-degree rotation to adjust the wing's position vertically or horizontally, contributing to the drone's ability to transition between takeoffs, hovering, and forward flight.

FIG. K: Depicts another servo motor with 180-degree rotation, responsible for fine-tuning the wing's vertical and horizontal positions.

FIG. R: Shows the front wing, which pivots vertically for lift during takeoff and rotates horizontally to enable hovering or gliding during flight, reducing the need for constant motor power.

FIG. 7: AI-Controlled Exercise Bike Battery Charger. Page 7 OF 7.

FIG. A: Heavy flywheel on the stationary exercise bike, connected to a DC generator, which converts mechanical energy from pedaling into electrical energy for charging the batteries.

FIG. B. Control monitor with an embedded AI system, responsible for monitoring the charge levels, user exercise data, and managing the switch between the two battery packs.

FIG. C. Pedals that allow the user to power the DC generator through exercise, driving the bike's flywheel.

FIG. H. The external view of the DC generator unit, which converts the flywheel's motion into electrical energy.

FIG. F. Battery compartment on the monitor, which holds 3×AA rechargeable batteries. The invention includes two such compartments, each holding 3×AA batteries for extended operation and energy switching.

FIG. D. Location of the DC generator, connected to the flywheel, responsible for generating power during exercise.

FIG. K Manual tensioner, which adjusts the resistance level of the flywheel. Some modern bikes use automatic tensioners that consume more energy, which reduces battery life.

FIG. E The bike's hollow fork that routes the electrical wiring from the DC

generator and speed sensor to the control monitor and battery packs, allowing efficient energy transfer and monitoring.

FIG. 8: Diag-1 AI-Controlled Dual Battery Electric Bike. Diag-1: Represents the AI-Controlled Dual Battery Electric Bike with integrated gyro wheels and a power generation system. Diag-2: Shows the top view of the two gyro wheel units. Page 8 OF 8.

Fig. A represents Battery Pack A, which includes an integrated Battery Management System (BMS).

Fig. B represents Battery Pack B, which also includes a Battery Management System (BMS).

Fig. C shows an extending arm welded to the bike frame, with an attached gear sprocket that meshes with the main bike drivetrain chain.

Fig. D illustrates Gyro-Wheel-1, which is supported by a steel shaft, two bearings, and an attached gear sprocket. The sprocket meshes by chain to a generator.

Fig. E illustrates Gyro-Wheel-2, which is also supported by a steel shaft, two bearings, and an attached gear sprocket. This sprocket meshes by chain to a generator.

Fig. F. Shows the bikes drivetrain chain.

Fig. K and Fig. P represent a double-geared sprocket on the axle that connects Gyro-Wheel-1 (sprocket K) and Gyro-Wheel-2 (sprocket P) to the bike's main drivetrain chain.

Fig. P and Fig. K (reverse notation) depict the double-geared sprocket on the axle connecting Gyro-Wheel-2 (sprocket P) and Gyro-Wheel-1 (sprocket K) to the main drivetrain chain.

Fig. H represents the power generator used to recharge the battery packs.

Fig. M. Fig. M shows how the gear sprocket of Gyro-Wheel-1 meshes with the generator by chain.

Fig. V depicts how the gear sprocket of Gyro-Wheel-2 meshes with the generator by chain.

Fig. W. Illustrates the support axle for the gyro wheels.

Fig. T. Represents the electric bike's frame chassis.

Fig. L. Shows the electric bike's monitor, which contains the embedded AI control systems.

### DETAILED DESCRIPTION OF THE INVENTION

The present embodiment presents a novel and efficient AI-controlled dual-battery charging system for electric vehicles, integrating advanced AI algorithms with mechanical components such as gyro wheels and planetary or ECVT gears.

This system is designed to optimize energy recovery, extend vehicle range, and reduce dependency on external power sources.

The detailed description, combined with the AI functionality and comparisons to prior art, demonstrates the novelty, non-obviousness, and industrial applicability of the invention, making it a strong candidate for patent protection.

It should be understood that while the embodiment of this invention has been shown and described, it is provided for illustrative purposes and may be modified by those skilled in the relevant art.

The claims herein are intended to encompass all such modifications that fall within the scope of the invention.

The details provided in the present embodiment, or any variety of embodiments described, are for demonstration purposes only and should not be construed as imposing any unnecessary inferences or limitations.

This invention presents a unified AI-controlled dual-battery charging system, designed to function across various electric-powered platforms, including vehicles, drones, and exercise equipment. Despite the different applications, the system remains fundamentally the same, utilizing dual battery packs, a gyro wheel, an alternator/generator, and an AI-controlled BMS and VCU. Each platform employs the same technical foundation and core components. To prevent any potential restriction requirement, we emphasize that the claims herein are directed to a single inventive concept. The adaptability of the system to different platforms does not constitute separate inventions but rather demonstrates the versatility and modularity of the system's core principles.

The existing components of the electric vehicle (EV) that the present embodiment utilizes have been cited in the reference pages with the appropriate device patent numbers listed. This ensures that the present embodiment's disclosure is not obscured by details already familiar to those skilled in the relevant arts.

For clarification and understanding, please note that the block diagram provided in this application is intended to illustrate the functional relationships and flow of electrical energy between components of the system across different devices. While the diagram focuses on EVs, its functional structure applies equally to other battery-operated platforms like bikes, drones, and exercise equipment, with minimal adjustments to scale and size.

The actual wiring schematics are extensive and would vary based on different implementation scenarios. Therefore, this block diagram offers a high-level representation, focusing on the system's operational concept rather than delving into the intricacies of each physical connection. It serves as a functional overview, focusing on the flow and interactions between system components rather than detailed wiring.

The detailed description will begin with FIG. 1 Version 1, followed by FIG. 2 Version 2 FIG-A, with the differences between the two versions presented progressively for clarity. While there may be some overlap in FIG. 1 and FIG. 2, this redundancy is intentional to ensure a clear understanding of the distinctions between the two versions.

The following section provides step-by-step instructions in a clear and structured format. Key information will be emphasized for clarity, ensuring that those skilled in the relevant field can easily understand and implement the embodiment.

The Detailed Figures and Block Diagram are provided in FIGS. 1 through 7, illustrating the mechanical and electrical integration of the AI-controlled dual-battery charging system, including the construction of the Gyro Wheel system, the workings of the Planetary or ECVT gear assembly, and the AI decision-making block diagram.

The AI Controller and VCU system see FIG. 5. FIG P, FIG K utilizes a PID controller FIG H to fine-tune the field voltage of the alternator. The PID output feeds into the AI system see FIG. 5. FIG H, FIG J, FIG F, that adjusts proportional, integral, and derivative actions in response to any deviation from set-points (e.g., target temperature or voltage).

The PID controller U.S. Pat. No. 4,903,192 for more details of its working principle is cited in Page 37 refer-39, calculates the optimal voltage by considering the current vehicle speed, battery SOC, and other sensor data. The AI adapts its parameters over time, learning from the vehicle's operational history to improve efficiency and can gather data beyond the PID's input, such as, user behavior (e.g., driving habits, acceleration, and braking patterns).

The VCU U.S. Pat. No. 10,661,805 see cited Page 34 refer-15 is integrated into the EV's existing systems, ensuring seamless operation and the prior art Patent can give more information of the working principles of this component which manages the vehicle's propulsion, speed, and torque, and it continuously sends operational data to the AI system. The AI uses this information to dynamically adjust alternator field voltage, modulate the Planetary or CVT gear system, and control battery pack switching based on the current driving conditions. The VCU ensures smooth integration between the energy recovery system and the vehicle's power requirements by relaying real-time performance metrics such as speed and torque to the AI. The VCU coordinates with the AI system to manage the alternator or generator, battery packs, and overall vehicle operation. This integration allows for real-time adjustments to the charging process based on driving conditions, extending the vehicle's range and improving overall efficiency.

The AI system U.S. Pat. No. 3,287,649 prior art see cited page 37 refer-40 can give more information of the working principles of this machine learning algorithm that in my embodiment is customized to predict optimal charging patterns under various driving conditions.

The AI programming code that controls the system is proprietary and has not been disclosed within this application. This decision is based on the following considerations:
1. Proprietary Nature: The AI programming constitutes confidential, proprietary information. The algorithms and code that govern the AI's operation have been custom-developed and are not critical for understanding the invention's structure or function. The absence of the AI code in this application does not affect the inventive aspects which are centered on the integration and control of the system's components.
2. Non-critical for Patent Claims: The novelty of the invention resides in the integration of the hardware components and control strategy. The specific AI programming code is not essential for the implementation or understanding of the claimed invention.
3. Sufficient Operational Details Provided: A detailed description of the AI's role and how it interacts with the system's components has been provided, ensuring that the operation of the AI is understood without requiring disclosure of the proprietary code.
4. Alternative AI Implementations: A skilled person in the field of AI can implement other suitable AI platforms or algorithms that will effectively integrate with this invention. The system has been designed to work with a variety of AI configurations, allowing for flexibility in its application depending on the specific needs of the user or industry.

The AI dynamically adjusts the alternator's field voltage and the timing of battery pack switching based on real-time data, ensuring the system operates within optimal parameters. Based on the input from the BMS and VCU, the AI system makes the following adjustments in real time.
A. The Alternator or Generator Field Voltage: The AI dynamically regulates the alternator's field voltage to optimize charging efficiency and prevent overloading. The AI control system uses this data to adjust the input field voltage of the alternator or generator, controlling the charging process dynamically. For instance, if the AI detects that the vehicle is accelerating, it may reduce the alternator's load to avoid unnecessary energy consumption. Conversely, if the vehicle is coasting or decelerating, the AI may increase the alternator's output to maximize energy recovery.
B. The Battery Pack Switching: When the SOC of the active battery pack reaches a predefined threshold that's best at 20% DOD, the AI switches to the second battery pack to ensure uninterrupted power supply.

The AI system is designed to operate using standard communication protocols (e.g., CAN bus), ensuring seamless integration with existing vehicle systems. By managing data flow between the BMS, VCU, and other vehicle subsystems, the AI ensures that energy recovery, battery management, and vehicle performance are synchronized. The AI control system is programmed to monitor real-time data from multiple sensors, including torque, speed, and voltage sensors. It dynamically adjusts the alternator's field voltage to optimize energy generation and battery charging.

This integration enables efficient energy recovery and battery management, significantly extending the vehicle's operational range while reducing the need for frequent external charging. Over time, the AI control system learns the driving patterns and adjusts the charging and discharging cycles accordingly, further optimizing the system's performance and extending the EV's range.

The Block diagram in FIG. 5, FIG E, FIG L, and FIG K shows the connection of the Alternator with the BMS and VCU, along with the AI system's connections to various sensors. The AI system uses these connections to monitor the vehicle's performance and adjust the charging process dynamically.

Version 2 Enhancement features a 15-degree pivoting arm shaft with a bevel pinion gear attached at the end of the axle shaft, enabling smooth gear engagement with the wheel rim's ring gear (see FIG. 4, Figs. D, B, and P). The design includes a ring gear welded to the inner rim barrel of the EV's wheel, allowing the bevel gear to mesh with the ring gear.

This setup causes the axle, connected to the ECVT's input shaft, to rotate, which in turn rotates the Gyro Wheel via the axle connected to the ECVT's output shaft. Additionally, the axle shaft pivots, facilitating easy wheel maintenance by allowing the bevel gear axle assembly to disengage from the wheel rim's ring gear, enabling quick removal and maintenance.

The AI Decision-Making Process see FIG. 5, block diagram illustrates the AI decision-making process that continuously compares the desired output voltage with the actual voltage see FIG F, FIG M and adjusts the field voltage accordingly. This process ensures that the alternator operates within optimal parameters, balancing energy recovery with battery health.

Gyro Wheel Mechanism (FIG. 1. Fig. O): is a key component that captures kinetic energy from the vehicle's momentum. The inclusion of a gyro wheel in the energy generation process significantly enhances the efficiency of the alternator or generator by providing additional torque and stabilizing power output. The size of the gyro wheel by the user to match specific vehicle performance goals is customizable. For instance, heavier gyro wheels provide greater energy storage but require more space and stronger supporting structures. Wheel Configurations depicted in Version 2 or Version 1 can be adapted or just by installing a single gyro wheel configuration is suitable for smaller vehicles, while dual gyro wheels provide additional torque and energy storage for larger EVs and commercial or heavy truck requirements.

This mechanism allows for continuous energy generation, even during vehicle deceleration, which is a clear improvement over the existing cited prior arts dual-battery systems that rely solely on conventional charging methods.

The Gyro wheel is designed for high-speed operation to rotate at speeds of 6000 RPMs, storing kinetic energy that is converted into mechanical energy to drive the Alternator or Generator.

This unit can be placed in several areas behind the EVs trunk compartment areas and hidden towards the midway as seen that fits in the most sold EV models. The Specifications of the Gyro Wheel Dimensions is designed to weigh between 60 and 85 pounds, with a diameter of 18.5 inches and a width of 3.5 to 4 inches to fit in its steel casing 20 inches in height and 13 inches wide see FIG. 1 Diag-2, FIG E and FIG F.

The Gyro Wheel is connected and mounted to the ECVT's output shaft a 30 mm thick alloy steel shaft with spline and keyway connection see FIG. 4. FIG O, FIG W, and supported by a series of cylindrical bearings FIG N to ensure smooth operation.

The Planetary or ECVT Gear System is designed for high-speed operation see (FIG. 4 Fig-K) it converts the rotational energy to the gyro wheel into mechanical torque. This system includes a central sun gear, planet gears, and a ring gear that work together to adjust the torque and speed, optimizing the input to the alternator or generator and housed within a steel casing to protect it from environmental factors and to maintain the integrity of the gears and other components.

The integration of an ECVT provides a similar benefit to the gyro wheel system as it allows for smooth transitions between different driving conditions, optimizing the torque and speed relationship without the need for discrete gear changes using just a regular type planetary gear system setup. The Alternative Gear Systems, such as the planetary gear system can be configured for vehicle requirements, but the embodiment can incorporate an ECVT Gear Box as described in U.S. Pat. No. 4,589,303 to Richard Roberts.

The Alternator or Generator (see FIG. 1, Fig. B) converts the mechanical energy generated by the Gyro Wheel, which is attached to the Planetary or ECVT gearbox, into Electrical Energy, which is used to charge the battery packs. The alternator or generator is designed to operate efficiently at high speeds and handle high power outputs, capable of producing up to 480 volts. It is equipped with a Voltage Controller that dynamically adjusts the input field voltage based on real-time data provided by the AI Control System to maintain the charge of the battery packs.

A Step-Up Transformer (U.S. Pat. No. 7,095,308) may also be utilized to increase the voltage from the alternator or generator to a level suitable for charging the high-voltage battery packs. See FIG. 5 Block Diagram how the unit Fig. D is connected and how it would receive power from the alternator/generator Fig. D and data flow to the rest of the system. The transformer is also connected to the external charging port, allowing the vehicle to be charged from an external power source when stationary, thus increasing the power for faster charging see Page 36, cited reference 33 for more details of the working principle.

The Step-Up Transformer is activated by the AI system when the vehicle experiences excessive slow down or reduced mechanical output from the gyro or gear system, leading to insufficient voltage generation for efficient charging. Under such conditions, the AI evaluates real-time vehicle dynamics and adjusts the power system by activating the transformer. This action boosts the voltage to the required levels, ensuring continuous and efficient battery charging. The AI can further adjust the transformer's activation depending on the battery state and vehicle conditions, optimizing both energy recovery and power distribution during varying operational states.

AI-Controlled BMS and VCU see (FIG. 5, FIG P, L, and K) in this embodiment serves as the central control unit responsible for optimizing energy recovery, battery usage, and vehicle operation. The AI continuously communicates with both the Battery Management System (BMS) FIG L, and the Vehicle Control Unit (VCU) FIG K, coordinating energy management based on real-time sensor data.

The AI-controlled BMS and VCU are central to the operation of the system. The BMS in this embodiment is designed to handle the complexities of dual-battery management, including switching between battery packs, balancing charge loads, and preventing overcharging. The AI-enhanced BMS ensures that the battery packs are maintained at optimal charge levels, which reduces wear and extends their operational life.

The (BMS) Patent No. 20240094790 and (VCU) U.S. Pat. No. 10,661,805 are integrated into the vehicle's existing systems, ensuring seamless operation and the prior art Patents can give more information of the working principles of these components. The VCU coordinates with the AI control system to manage the alternator/generator, battery packs, and overall vehicle operation. This integration allows for real-time adjustments to the charging process based on driving conditions, extending the vehicle's range and improving overall efficiency.

The AI system continuously monitors data from various sensors, including torque sensors, speed sensors, and voltage sensors. See FIG. 3 Diag-4 for the depiction flow of data, and based on this data, the AI control system adjusts the alternator/generators field voltage to optimize charging efficiency and energy recovery.

The BMS ensures that the battery packs are charged in a balanced and safe manner, switching between Battery Pack A and Battery Pack B as needed to maintain the vehicle's operation see depiction FIG. 3 FIG F BMS, FIG D Switch and FIG. 1 battery A and FIG. 2 battery B.

The BMS provides essential data such as voltage levels, temperature, and current charge/discharge rates, which the AI system uses to optimize alternator/generators output and battery switching process and ensures that the battery packs are maintained at optimal charge levels, which reduces wear and extends their operational life and mitigates the risk of overcharging or deep discharging, which are common issues in less advanced dual-battery systems.

This continuous data exchange allows the AI to make real-time decisions about when to switch between battery packs, ensuring that one battery pack is always charging while the other powers the vehicle.

For more clarity, the Initial embodiments system setup is initialized with the Battery Pack A connected to the EV's main and motor circuit, providing power for propulsion. Battery Pack B is connected to the Alternator or Generators Circuit, ready to receive a charge and completely off the EV, s Main and Motor Circuit.

The battery pack switching activates accordingly as the AI-controlled BMS monitors the SOC of both battery packs. When the active battery pack (e.g., Battery Pack A) reaches a DOD threshold (typically around 20% but will be adjusted accordingly by the AI as it learns user driving pattern and external driving modes), the system automatically switches to the fully charged battery (e.g., Battery Pack B). The depleted (Battery Pack A) is then completely isolated from the vehicle's main electrical and motor circuit and connected to the alternator or generators circuit for recharging.

The Energy Generation is achieved by using the Vehicles Forward Momentum. As the vehicle accelerates, the Gyro Wheel begins to rotate and accelerate. The AI controls the Field Voltage at the alternator or generator as low of voltage as possible, as the ECVT gear system and Gyro Wheel continues its high-speed operation and reaching 6000 rpms as this number can be easily modified either to a higher or lower rpms for efficient energy transfer to the Alternator or Generator during steady-state cruising speeds which generates electricity, and directed to the battery pack that is currently not in use and disconnected from the main and motor circuit, thereby maintaining its charge for faster charging.

The Dynamic Voltage Regulation is controlled by the AI system that adjusts the Alternator or Generators field voltage in real-time, optimizing the charging process based on the vehicle's speed, the gyro wheel's rotational speed, and the current SOC of both battery packs. This dynamic regulation ensures that the Alternator or Generator operates efficiently, providing the maximum possible charge to the battery packs without overloading the system.

The Energy Recovery is extended as the gyro wheel continues to rotate at high speeds, allowing the Alternator or Generator to continue generating electrical energy further extending the vehicle's range, by capturing kinetic energy during both acceleration and deceleration, the system maximizes the energy available for battery charging.

This feature is particularly beneficial for urban driving conditions, where frequent stops and starts would otherwise result in significant energy losses. The system's ability to recover and reuse this energy contributes to a longer driving range and reduced reliance on external charging stations.

The present invention is designed to integrate seamlessly with existing EV systems and their electrical architecture. This compatibility reduces the need for extensive modifications, making it easier to retrofit existing EVs with the current embodiment by implementing AI programming platforms and learning algorithms. These platforms use standard interfaces and communication protocols to ensure compatibility and efficient operation across various platforms.

The system is modular and highly adaptable, meaning that the present embodiment's components—such as the gyro wheel, planetary or ECVT gearbox, and alternator/generator—can be tailored to a vehicle's specific requirements. This flexibility makes the system suitable for a wide range of EVs. For instance, this AI-controlled dual-battery system is designed to be adaptable for different platforms, ranging from small electric scooters and bikes to larger, more robust systems for commercial vehicles and trucks. The modular nature of the system allows for easy integration into various vehicle types without requiring extensive modifications.

For example, in smaller platforms like electric bikes and scooters, the system can be scaled down to meet lower power requirements. The lightweight design of the gyro wheel and gearbox system makes it an ideal solution for extending the range of these vehicles without adding significant weight. The AI's learning capabilities can also tailor energy management to the specific power needs of bikes and scooters, optimizing energy use based on the rider's habits and terrain.

Refer to FIG. 8, Fig. A and B, which depict an electric bike configured with dual 48-volt battery packs. This system is scaled down for smaller energy production, sufficient to meet the bike's energy requirements, with AI-controlled power management. As seen in this embodiment, the same principle and construction process are applied, though scaled down to fit the needs of smaller vehicles.

For electric drones, the system is adapted to maximize flight duration and energy efficiency. The AI monitors flight conditions, including wind speed and altitude, and adjusts battery usage accordingly. Refer to FIG. 6 FIG. R and FIG. P that shows an adapted front and rear wing, which pivots vertically for lift during takeoff and rotates horizontally to enable hovering or gliding during flight, reducing the need for constant motor power. Which leaves the main rotor free to capture energy during hovering or descent and other low-power flight phases, extending flight time and reducing the frequency of battery changes or charging. By leveraging AI to dynamically control the pitch of both wing rotors and adjust based on real-time wind data, the drone can maximize energy recovery while maintaining flight and stability. The optimal pitch for the main wing rotor Fig R and rear wing rotor Fig P can be fine-tuned by the AI to harness the wind's power, even at high altitudes where airflow is strong but turbulent.

The pitch angle of both the main wing rotor and the rear wing rotor determines how effectively they can capture wind and convert it into flight time without expending battery usage thereby extending flight time extensively.

By adjusting the pitch to capture the most airflow (wind striking the blades at an optimal angle), you can maximize the amount of force that turns the motor and generates electricity to recharge the battery while drone is hovering. At higher altitudes, wind speeds are generally stronger but more turbulent. This means your drone needs to balance stability with energy capture. The main rotor and rear rotor need to dynamically adjust their pitch angles to catch the most consistent airflow. The main rotor (which typically provides lift) can be adjusted by the AI control system to take advantage of the updrafts or horizontal wind streams by changing its pitch angle to an optimal degree. Similarly, the rear rotor, which normally stabilizes yaw, can be repurposed in high-altitude conditions to capture airflow and contribute to rotational energy recovery.

By using wind to stay afloat one reduce motor strain, your system directly reduces the drone's energy consumption. This aligns perfectly with the goal of maximizing battery life, which is a critical limitation in drone technology today. The AI's ability to adjust the wing flaps in real time based on wind conditions adds a layer of sophistication, making the drone not only energy efficient but also adaptable to different environmental conditions. This could have significant applications in drones used for delivery, surveillance, or extended flights where power efficiency is paramount. The modification would allow drones to stay in the air longer without relying solely on battery power, which is a significant competitive advantage. In scenarios where drones are deployed for tasks like long-range delivery or reconnaissance, the extended flight time due to wind harnessing can reduce operational costs and increase efficiency. The AI's capability to autonomously adjust flight controls based on wind patterns is a groundbreaking feature. This could open up applications in various sectors where autonomous, long-range, or high-endurance drones are required.

The drone's system includes an innovative battery recharging mechanism that operates while the drone is in flight. This mechanism leverages the airflow generated during hovering and forward flight to continuously spin the drone's propellers. As the propellers rotate, the motor (which also functions as a generator) converts the rotational energy into electrical energy, which is then used to recharge the dual batteries mid-flight.

The jet stream and wind forces generated by the drone's movement and hovering push air against the propellers, causing them to spin. This mechanical rotation is transferred to the motor-generator unit, which recharges the drone's battery pack that's off the main and motors circuit without relying on external power sources.

The AI system see FIG. 6 (Fig. H) continuously monitors the propeller's speed and battery state of charge (SOC), optimizing the balance between flight efficiency and energy recovery. This allows the drone to maintain longer flight durations, especially in windy conditions where more energy can be harvested from the environment. Page 37 ref-37 U.S. Patent No. 20200052570 discusses an electric aircraft system that uses a high-efficiency generator driven by airflow. The design minimizes reverse torque, allowing efficient conversion of mechanical energy from airflow into electrical energy, much like my embodiments drone's system would aim to do by converting wind force into rotational energy for recharging, but using advance AI and wing modification as shown with the included dual battery packs. The system introduces a unique enhancement for drones by integrating AI-controlled wing structures with servo motors as depicted in drawings page FIG. 6. These wings adjust based on wind conditions, allowing the drone to harness wind energy to stay aloft while reducing motor power usage. The drone can also harness wind energy to recharge a secondary battery pack while in flight. This significantly extends flight time and improves energy efficiency, making it ideal for long-range and high-endurance tasks such as surveillance or deliveries.

For larger commercial applications, such as delivery trucks and buses, the embodiments high-capacity gyro wheel and alternator/generator provide a continuous source of energy during long-distance trips. The present inventions dual-battery system ensures that one battery is always charging while the other is in use, significantly extending the range of these vehicles and reducing downtime at charging stations. The process is basically the same except a more robust equipment is just required for trucks and buses, such as, larger Gyro wheel or multiple gyro wheels, a robust ECVT gear box a stronger Alternator/generator unit, configured with the AI control system and following the same process will achieve the same results for a successful mileage enhancement of these larger EV's.

Conclusion: I have included additional cited references, not directly utilized in the present embodiments, to acknowledge the respective past inventors and their technological contributions. This invention introduces a unified AI-controlled dual-battery charging system designed for various electric-powered platforms, such as vehicles, drones, and exercise equipment. Despite the diverse applications, the system remains consistent, employing dual battery packs, a gyro wheel, an alternator/generator, and an AI-controlled BMS and VCU. Each platform shares the same technical foundation and core components. This approach avoids potential restriction requirements, as the claims pertain to a single inventive concept. The system's adaptability across platforms demonstrates the versatility and modularity of its core principles, rather than constituting separate inventions.

### REFERENCES CITED

1. U.S. Energy Administration. (2017). EIA/Energy Explained: Energy and the Environment. EAI.gov.
2. Fuel Economy Gov. (n.d.). *Fuel Economy Explained. fueleconomy.gov*.
3. USPTO. (2012). Fast Switching for Power Inverter (Patent No. 20120195085). Kroeze; Ryan et al.
4. USPTO. (2010). Self-Charging (SC-EV) (Patent No. 20100019722). Sanchez; David M.
5. USPTO. (2013). 21.07 Guidelines: 35 U.S.C.101, 35 U.S.C 112 (a) Compliance with Utility Requirements.
6. USPTO. (2014). Battery Mounting and Cooling System (Patent No. 20140178722). Straubel; Jeffrey B. et al.
7. USPTO. (2013). Dual Mode Range Extended Electric Vehicle (Patent No. 20130066506). Kelty; Kurt Russell et al.
8. USPTO. (2015). Electro Magnet Switch with Damping Interface (Patent No. 20150155112). Goldman; Mark et al.
9. USPTO. (n.d.). Definitions Classification: Dynamo-Electric Machines H02K/H02P covers wide range including Dynamo Electric Braking Systems.
10. USPTO. (2012). Dual Source Battery Pack System for an Electric Vehicle (Patent No. 20120041627). Teslas Motor, Kelty; Kurt Russell et al.
11. USPTO. (2013). Electric Vehicle Extended Range Hybrid Battery Pack System (Patent No. 20130181511). Stewart; Sarah G. et al.
12. USPTO. (2015). Charging Station Providing Thermal Conditioning of Electric Vehicle During Charging Session (Patent No. US20150306974). Teslas Motor, Mardall; Joseph et al.
13. USPTO. (2019). Electromagnetic Switch with Stable Moveable Contact (Patent No. 20190108958). Tesla motor, Sprague; Bennett et al.
14. USPTO. (2017). Voltage Sensor Device (U.S. Pat. No. 9,797,930). Podzemny; Jaromir et al.
15. USPTO. (2020). Vehicle Control Unit (VCU) And Operating Method (U.S. Pat. No. 10,661,805B2) Jung; Daebong et al.
16. USPTO. (2024). Jump Starters (U.S. Pat. No. 11,752,894B2). Wekwert; James et al.
17. USPTO. (2023). Dual Battery Charging Method for Managing Charging and Discharging (Patent Application No. 20230216326A1). Dennis M Hogan.
18. USPTO. (2024). Battery Management System (Patent No. 20240094790) uses programming codes to control its state of charge and health. Yasuhide Kurimoto
19. USPTO. (2010) All-Solid-State Battery (Patent No. US20100273062) Tsuchida; Yasushi et al.
20. USPTO. (2024). Dual-Battery Charging System for Electric Vehicles (Patent No. US20240253522) Bishai; Kerolos
21. USPTO. (2024). Apparatus and Method for Rapid Charging Using Shared Power Electronics (U.S. Pat. No. 11,884,168B2). King; Robert Dean et al.
22. USPTO. (2021). Battery Thermal Management (U.S. Pat. No. 10,953,726B2). Carlson; Michael H. et al.
23. USPTO. (2023). Vehicle Energy Management System and Related Methods (U.S. Pat. No. 11,766,951B2). Healy; Thomas Joseph et al.
24. USPTO. (2024). Systems, Methods, and Devices for Health Monitoring of an Energy Storage Device (U.S. Pat. No. 11,860,130B2). Sood; Bhanu et al.
25. USPTO. (2024). Battery Management System (U.S. Pat. No. 11,865,941B2). Manages vehicles battery devices to control its state of charge and health. Suzuki; Daisuke
26. USPTO. (2023). Backup Vehicle Battery (Patent No. 20230134140A1). Williams; Robert
27. USPTO. (2023). Charging Device and Control Method Therefor (Patent No. 20230138183A1). Yang; Dong et al.
28. USPTO. (2018). Power Storage System and Power Storage Method (Patent No. 20160322859A1). YAMAMOTO; Kazuhiro et al.
29. USPTO. (2010). Auxiliary Battery Attachment Apparatus for Use in a Multiple Battery System (U.S. Pat. No. 7,675,261B2). Elder; David W. et al. USPTO. (2014). Method and Apparatus for Battery Control (Patent No. 20140253045A1). Poznar; Tomasz.
30. USPTO. (2016). Battery Pack (U.S. Pat. No. 9,350,186B2). Ju; Ri-A et al.
31. USPTO. (1986). Continuously Variable Transmission (CVT) with Synchronous Shift (U.S. Pat. No. 4,589,303). Roberts; Richard W.
32. USPTO. (2024). Auxiliary Battery Attachment Apparatus for Use in a Multiple Battery System (U.S. Pat. No. 7,675,261B2). Elder; David W. et al.
33. USPTO. (2006). Step-Up Transformer (U.S. Pat. No. 7,095,308). Kobayashi; Kenichi
34. USPTO. (1967). North-Seeking Gyro System (U.S. Pat. No. 3,307,412) Carl-Eric Granqvist.
35. USPTO. (2013) Powertrain with two planetary gear sets and two motor/generators for hybrid vehicles (Patent No. U.S. Pat. No. 8,409,040 B1) GV; Ravikanth et al.
36. USPTO. (2021) Vehicle comprising a wheel driven generator for charging a battery (U.S. Pat. No. 10,931,165 B2) Van Wijk; Rudolf Johannes.
37. USPTO. (2020) Turbofan Jet Engine, Powered By an Electric Motor with Power from A High Efficiency Electric Generator. (US-20200052570-A1) Holcomb; Robert Ray.
38. USPTO. (2023) Vtol Aircraft (U.S. Pat. No. 11,753,159B2) Joby Aviation.
39. USPTO. (2020) Pid controller system (U.S. Pat. No. 4,903,192-A) Saito; Tadayoshi et al.
40. USPTO. (1966) Audio signal pattern perception device (U.S. Pat. No. 3,287,649-A) FRANK ROSENBLATT.

1. An AI-controlled dual-battery charging system for electric-powered vehicles, including electric-powered trucks, buses, delivery vehicles, scooters, electric bikes, drones and battery-operated exercise equipment, comprising:
A Two independent battery packs, each configured to separately supply power to the vehicle's electric motor, wherein the battery packs are either lithium-ion or solid-state battery packs;
B A gyro wheel mechanism configured to generate mechanical torque from vehicle momentum;
C A planetary or electronically controlled continuously variable transmission (ECVT) gear system connected to the gyro wheel to modulate torque output;
D An alternator or generator connected to the planetary or ECVT gear system, configured to convert torque into electrical energy and charge a second battery pack while a first battery pack powers the vehicle;
E An AI-controlled Battery Management System (BMS) and Vehicle Control Unit (VCU), configured to dynamically switch between the two battery packs based on their state of charge (SOC), depth of discharge (DOD) and real-time vehicle conditions.

2. The system of claim 1, wherein the gyro wheel mechanism is configured to spin at high speeds to provide continuous charging of the second battery pack during vehicle motion, optimized for stop-and-go traffic.

3. The system of claim 1, further comprising a dual gyro wheel configuration, wherein each gyro wheel is mounted on opposite sides of the vehicles axle, enhancing torque output and energy recovery.

4. The system of claim 1, wherein the planetary or ECVT gear system comprises sun gears, planet gears and a ring gear housed within a steel or lightweight alloy casing, configured to accommodate the torque demands of electric-powered vehicles

5. The system of claim 1, wherein the alternator or generator is configured with a dynamic voltage controller regulated by the AI system, capable of adjusting power output based on real-time driving conditions, vehicle load and energy needs.

6. The system of claim 1, further comprising a cooling system integrated with the gyro wheel housing and planetary or ECVT gear system, configured to use cooling fluids to maintain optimal operating temperatures.

7. The system of claim 1, wherein the AI system is configured to monitor vehicle speed, battery status, gyro wheel speed and environmental factors to optimize switching between battery packs and alternator output, particularly for long-range and high-load conditions.

8. The system of claim 1, further comprising an adaptive regenerative braking system configured to work with the gyro wheel mechanism to capture energy during vehicle deceleration and charge the battery packs.

9. The system of claim 1, wherein the AI system dynamically adjusts the alternator field voltage to maximize charging efficiency during various driving scenarios.

10. The system of claim 1, wherein the dual-battery system is adaptable for use in electric-powered trucks, buses, scooters, electric bikes, drones and battery-operated exercise equipment, with tailored adjustments to the BMS and AI system to suit the specific energy requirements of lithium-ion or solid-state battery packs for each platform.

11. The system of claim 1, wherein the AI-driven BMS includes predictive algorithms configured to adjust alternator field voltage in response to real-time data from vehicle sensors, gyro wheel speed and terrain-based navigation data.

12. The system of claim 1, wherein the alternator or generator is a high-output model capable of producing variable amperage to accommodate different vehicle speeds, battery states and electrical loads

13. The system of claim 1, wherein the alternator output is regulated by a Proportional-Integral-Derivative (PID) controller, optimizing energy transfer between the gyro wheel and battery packs.

14. The system of claim 1, wherein the gyro wheel is configured to operate in forward and reverse directions, enabling energy recovery during reverse motion or braking.

15. The system of claim 1, further comprising an energy recovery module integrated with the gyro wheel and regenerative braking system to capture mechanical and kinetic energy for battery charging.

16. The system of claim 1, wherein the dual-battery charging system is configured for integration into electric-powered vehicles, including cargo trucks, buses and delivery vehicles, with adaptive AI controls for specific operational demands.

17. The system of claim 1, wherein the alternator or generator includes a high-frequency inverter configured to convert mechanical energy from the gyro wheel into electrical energy for rapid charging of battery packs.

18. The system of claim 1, further comprising a modular design for the gyro wheel and planetary or ECVT gear system, allowing easy installation, removal and maintenance in various vehicle configurations.

19. The system of claim 1, wherein the AI system integrates with external navigation and telematics systems to optimize charging cycles based on road conditions, traffic and weather data.

20. The system of claim 1, wherein the AI system dynamically adjusts the gear ratios of the planetary or ECVT system to optimize the rotational speed and torque of the gyro wheel.

21. The system of claim 1, further comprising a pivoting arm shaft with a bevel pinion gear, allowing easy engagement with the wheel rims ring gear for enhanced maintenance accessibility

22. The system of claim 1, wherein the alternator is connected to a step-up transformer to increase voltage output for more efficient battery charging, particularly in larger vehicles like trucks and buses.

23. The system of claim 1, wherein the AI system includes machine learning algorithms to predict optimal charging patterns based on historical driving or usage conditions.

24. The system of claim 1, wherein the drone further comprises a servo motor mounted on the midsection of the drones frame, attached to small wing structures on each side of the drone, configured to pivot up to 180 degrees for adjusting wing alignment during flight.

25. The system of claim 24, wherein the AI system analyzes wind direction and adjusts the servo motor to optimize wing flap positions, allowing the drone to capture wind for lift and hover with reduced motor power consumption.

26. The system of claim 24, wherein the wing structures, controlled by the AI system, transition from a vertical position during takeoff to an optimized angle during flight, enabling the drone to glide or hover using external wind forces.

27. The system of claim 1, wherein the AI system monitors wind speed and direction in real time, adjusting the servo motor and wing structures to maintain stable flight with reduced battery usage, thus extending the drones flight time.

28. The system of claim 1, wherein the AI-driven control system for the drone's wing structures includes algorithms that predict optimal flight paths based on wind patterns, allowing the drone to remain airborne longer with reduced reliance on motor power.

29. The system of claim 1, wherein the dual-battery configuration utilizes solid-state battery packs to enhance energy density, safety and longevity, particularly in extreme temperature conditions.

30. The system of claim 1, wherein the solid-state battery packs provide enhanced safety and energy efficiency due to their solid electrolyte material, which mitigates risks associated with thermal runaway in extreme temperature environments compared to conventional lithium-ion batteries.

31. The system of claim 1, wherein the drones propellers continue to spin due to airflow generated during hovering or forward flight, driving the motor, which also functions as a generator to recharge the battery packs during flight.

32. The system of claim 31, wherein the motor-generator unit captures the mechanical energy from the spinning propellers and converts it into electrical energy, enhancing flight duration and reducing the need for external charging.

33. The system of claim 31, wherein the AI system monitors propeller speed and adjusts the energy recovery process to optimize battery recharging based on wind conditions and the drone's flight patterns.
